(19) United States
(12) Patent Application Publication
(10) Pub. No.: US 2009/0155127 A1
(43) Pub. Date: Jun. 18, 2009

(54) APPARATUS FOR HOLDING A SPECIMEN CONTAINER AND METHOD OF USE

(75) Inventor: Marc S. Kopoian, Scottsdale, AZ (US)

Correspondence Address: MESCHKOW & GRESHAM, P.L.C., 5727 NORTH SEVENTH STREET, SUITE 409, PHOENIX, AZ, 85014, US

(73) Assignee: Choyce Products, Inc., Scottsdale, AZ (US)

(21) Appl. No.: 12/136,586

(22) Filed: Jun. 10, 2008

Related U.S. Application Data
(60) Provisional application No. 61/014,683, filed on Dec. 18, 2007.

(51) Int. Cl. B01L 3/00; B01L 9/00

(52) U.S. Cl. 422/102; 422/104; 73/864.91

(57) ABSTRACT

A specimen container holder (12) aids in the collection of a biological specimen (16). The holder (12) securely holds and supports a specimen container (14) in a gripping unit (88) made of two arcuate fingers (36) and (40) attached to a handle (28). Subsequent to specimen collection, the specimen container (14) can be disengaged from the holder (12) by pressing (104) on the handle (28) with one hand.

### RELATED INVENTION

The present invention claims benefit under 35 U.S.C. §119(e) to “Apparatus for Holding Specimen Cup and Method of Use,” U.S. Provisional Patent Application Ser. No. 61/014,683, filed Dec. 18, 2007, which is incorporated in its entirety by reference herein.

### TECHNICAL FIELD OF THE INVENTION

The present invention relates to the field of holding devices for specimen containers of a type used in the medical field and elsewhere to collect, hold, and transport biological or other specimens obtained from patients or other sources.

### BACKGROUND OF THE INVENTION

Specimen containers are used in physicians' offices, hospitals, and private labs in order to obtain urine or other samples from patients. Often the patient is expected to provide the sample in the privacy of a restroom within the facility itself. In such situations, the patient is expected to hold the sample container and collect the specimen. For young children or disabled patients, other family members may assist in this procedure. Regardless of who is actually collecting the sample, often the individual holding the container will soil their hands while collecting the sample. In the event that a mid-stream urine sample is required, where the patient begins to urinate in either a bed pan or the toilet and then insert the specimen container into the urine stream to collect an uncontaminated sample, the chances of soiling one's hand is a frequent problem.

The patient is not the only person who must touch this specimen container. After a specimen is provided by the patient, the container is then given to a nurse, lab technician or other individual who works at the organization where the sample was collected. Not only is it likely that one's hands become soiled in the process of collecting a specimen, but it is also likely that the exterior of the container has been soiled. The soiled portion of the container is not generally limited to a small portion; rather, a majority of the container may be soiled before the individual is able to wipe the container. Generally at the time the sample is collected, all parties are unaware of any potential diseases or conditions that the specimen donor may have. Other individuals who handle the contaminated specimen container may be in danger of becoming exposed to these diseases or conditions.

The potential transferring of diseases and the possible contamination of the outside of the specimen container are not the only problems. There are many people that must handle the specimen container both during the process of transporting, and while testing the specimen held within the container. Whether or not there was in fact any actual contamination, these people are often displeased about having to touch the container, and would appreciate not having to touch it.

The distaste for holding the specimen container is only increased with the potential that the container may have been soiled in the process of collecting the specimen, both from the specimen splashing out of the container, and also from being inserted into the specimen stream.

This problem has been addressed to some extent by conventional inexpensive, disposable specimen container holding devices. With such devices a user holds the holding device while the holding device holds the specimen container. Thus, the user may reduce direct contact with the specimen container itself. But the conventional devices have their own disadvantages. Some place the specimen container within a tight ring which holds the container securely during the collection process. But the process of removing the container from such a ring can lead to potential spilling or loss of the sample. Furthermore, the removal of a secured specimen container from a conventional specimen container holder typically requires the use of two hands. One hand holds the specimen container holder while the second hand either pulls the specimen container out of the holder by the cap, or pushes the specimen container out of the holder from underneath the holder. In either situation, there is the potential that the hands of the individual removing the specimen container can be soiled by the outside of the container.

There is no standard size for specimen containers. Different manufacturers manufacture such containers in different diameters. In order to utilize conventional specimen container holders, the precise diameter of the specimen container must be known, as the ring holding the container is molded into a set diameter, unable to adapt to different size sample containers.

Also, many conventional specimen container holding devices are often made from rigid, brittle plastics. As mentioned earlier, there are many different specimen container diameters. Due to the rigidity of many of the conventional specimen container holding devices, these devices cannot expand to accommodate a variety of these different diameters. Instead, it is typically necessary to specially mold rings for different containers. Furthermore, the brittle nature of these holding devices makes them liable to break when force is applied.

Some of these also have vertical reinforcements on the bottom of the handle. These reinforcements encourage a user to grip the holder primarily on the sides, vertically, instead of horizontally. This is because the vertical reinforcements concentrated pressure at the narrow lines of contact with the user's finger at the bottom of the handle. This is unsuitable for exerting much in the way of a downward force. Consequently, these reinforcements encourage the two handed specimen container removal technique discussed above.

### SUMMARY OF THE INVENTION

Accordingly, it is an advantage of at least one embodiment of the present invention that an improved apparatus for holding a specimen container and a method of use are provided.

Another advantage of at least one embodiment of the present invention is that a device and method are provided to allow an individual to easily and securely place a specimen container to accept urine or other sample while seated upon a toilet.

It is still another advantage of at least one embodiment of the present invention that a device and method are provided that can securely hold multiple sizes of specimen containers while receiving urine or other samples.

Still another advantage of at least one embodiment of the present invention is that a system for collecting and transporting specimens is provided that limits the surface area soiled while receiving a specimen.

Another advantage of at least one embodiment of the present invention is that a device and method are provided that easily releases a specimen container subsequent to having received the specimen.

The above and other advantages are carried out in one form by an improved specimen container holder. This specimen container holder has a handle. Attached to the handle two arcuate fingers are oriented so that these fingers can securely hold a specimen container.

Further advantages of this specimen container holder will become apparent from a consideration of the drawings and ensuing description.

### BRIEF DESCRIPTION OF THE DRAWINGS

A more complete understanding of the present invention may be derived by referring to the detailed description and claims when considered in connection with the Figures, wherein like reference numbers refer to similar items throughout the Figures, and:

FIG. 1 shows a top perspective view of a specimen container holder depicting the holder securing a specimen container in accordance with a preferred embodiment of the present invention;

FIG. 2 shows a top perspective view of a specimen container holder in accordance with a preferred embodiment of the present invention;

FIG. 3 shows a side perspective view of a specimen container holder in accordance with an alternative preferred embodiment of the present invention;

FIG. 4 shows a side perspective view of a specimen container holder in accordance with an alternative preferred embodiment of the present invention;

FIG. 5 shows a planar view of a specimen container holder in accordance with a preferred embodiment of the present invention; and

FIG. 6 shows a perspective view of a specimen container holder depicting a method of using the specimen container holder in accordance with a preferred embodiment of the present invention.

### DETAILED DESCRIPTION OF THE PREFERRED EMBODIMENTS

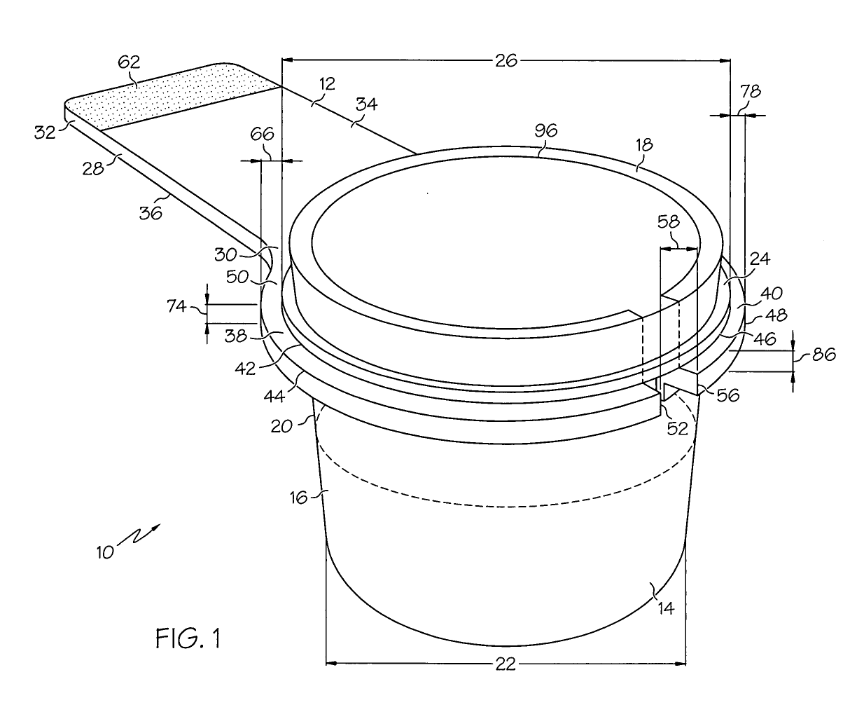

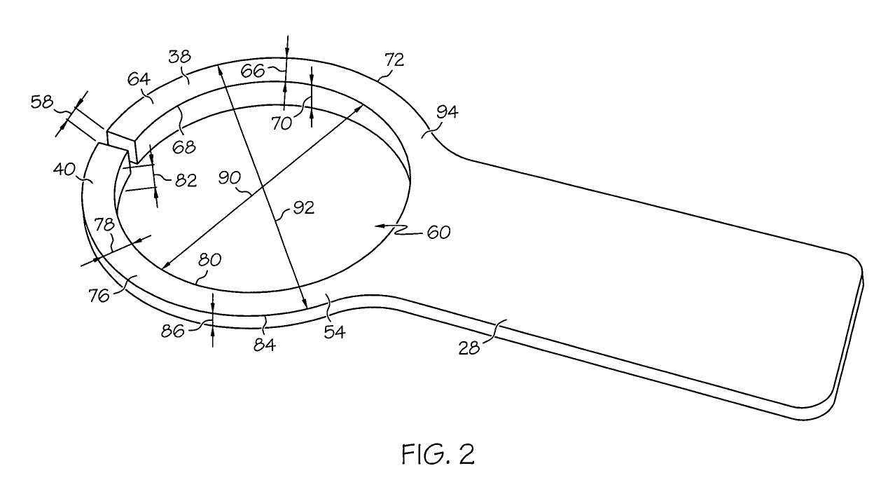

FIG. 1 shows a perspective view of a system 10 made up of a specimen container holder 12 and a specimen container 14. Specimen container 14 can be manufactured by many different companies, having different diameters and shapes. Typically, specimen container 14 has a screw top lid 18 to prevent the collected specimen 16 from spilling. The side walls 20 of specimen container 14 can be tapered, such that the diameter 22 of specimen container 14 is greater at lid 18 than it is below lid 18, or can be straight, such that the diameter 22 is constant over the full length of specimen container 14. There may be external molded features 24 that increase the greatest diameter 26 of specimen container 14. Specimen container 14 is securely placed within specimen container holder 12 prior to an individual using the system to collect a specimen 16. Specimen container holder 12 has a handle 28, this handle 28 having a proximal end 30 and a distal end 32. Handle 28 also has a top face 34 and bottom face 36. Proximal end 30 is intended to be nearer specimen container 14 during normal use and distal end 32 is intended to be farther from specimen container 14 during normal use. Connected to proximal end 30 is a first arcuate gripping finger 38 and a second arcuate gripping finger 40. First arcuate gripping finger 38 has a concave side 42 and a convex side 44. Second arcuate gripping finger 40 has a concave side 46 and a convex side 48. Concave side 42 of first arcuate gripping finger 38 and concave side 46 of second arcuate gripping finger face each other, and convex side 44 of first arcuate gripping finger 38 and convex side 48 of second arcuate gripping finger 40 face away from each other. First arcuate gripping finger 38 has a secured end 50 and an open end 52. Second arcuate gripping finger 40 has a secured end 54 (shown in FIG. 2) and an open end 56. Secured ends 50 and 54 are intended to be nearer handle 28, secured at the proximal end 30 of handle 28, and open ends 52 and 56 are intended to be farther from handle 28. Open ends 52 and 56 do not touch, providing a small gap 58 there between. Concave sides 42 and 46 of arcuate gripping fingers 38 and 40 form an opening 60 (circumscribed by a dotted line in FIG. 2) which is configured to securely hold specimen container 14.

Top face 34 at distal end 32 of handle 28 has a textured area 62 formed as a pattern of small peaks and valleys molded into handle 28. Textured area 62 provides traction where a user's hand, typically the user's thumb, holds handle 28. The traction helps the user grip the holder securely not only while collecting a specimen, but also while extracting specimen container 14 from specimen container holder 22.

FIG. 2 shows a perspective view of specimen container holder 22. First arcuate gripping finger 38 has a top face 64 having a width 66, a concave rim 68 having a concave thickness 70, and a convex rim 72 having a convex thickness 74 (shown in FIG. 1). Second arcuate gripping finger 40 has a top face 76 having a width 78, a concave rim 80 having a concave thickness 82, and a convex rim 84 having a convex thickness 86. Width 66 is the radial distance between the concave rim 68 and convex rim 72. Width 78 is the radial distance between the concave rim 80 and convex rim 84. Convex thicknesses 74 and 86 are substantially the same, and concave thicknesses 70 and 82 are substantially the same. Also, widths 66 and 78 are substantially the same.

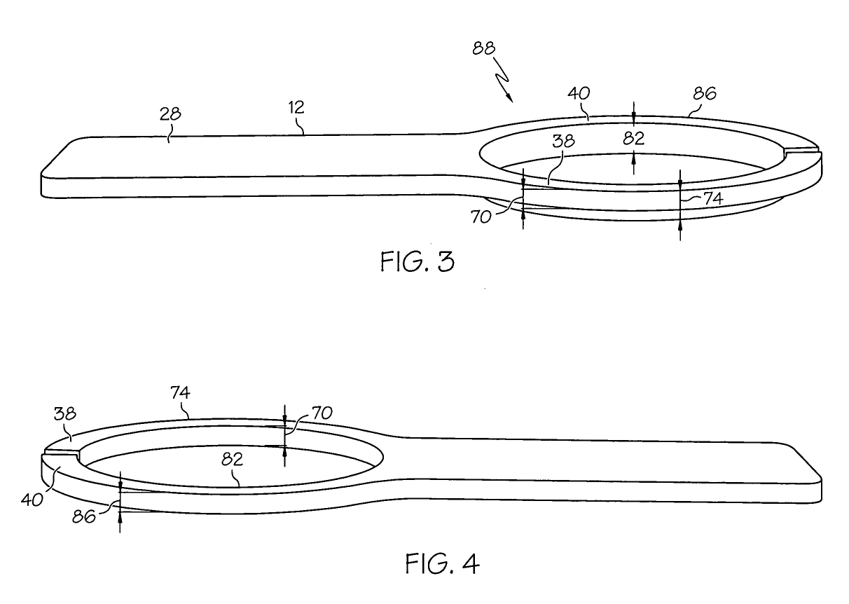

Concave rims 68 and 80 and proximal end 30 of handle 28 are joined together to form a specimen container gripping unit 88 (circumscribed by a dotted line in FIG. 3). Gripping unit 88 is substantially planar with handle 28 and has an internal diameter 90 and an external diameter 92. Those skilled in the art would recognize that although specimen container gripping unit 88 is not a full circle, due to gap 58, the substantially circular shape is viewed as having an internal diameter 90 and external diameter 92. Internal diameter 90 is the diameter of the substantially circular shape formed by concave rims 68 and 80 and the proximal end 30 of handle 28. External diameter 92 is the diameter of the substantially circular shape formed by convex rims 72 and 84 and the proximal end 30 of handle 28. The difference in length between internal diameter 90 and external diameter 92 is equal to the sum of the lengths of widths 66 and 78. Gripping area 48 also has a top face 94. When specimen container 14 is secured within specimen container gripping unit 88, part of specimen container 14 is below the top face 94 of gripping unit 88.

In a preferred embodiment of the present invention, gripping unit 88 has a substantially circular shape, with gap 58 where open ends 52 and 56 approach each other. Those skilled in the art will recognize that arcuate gripping fingers 38 and 40 need not span the full circumference of specimen container 14, but rather only need to span more than one half of the circumference of the container 14. As the specimen container 14 has a circular shape, as long as an angular distance 96 (shown in FIG. 1) of more than 180° of the specimen container 14 is spanned by arcuate fingers 38 and 40, specimen container holder 12 can hold specimen container 14. In a preferred embodiment, angular distance 96 is more than 350°.

Widths 66 and 78 reduce the likelihood of contaminating or soiling the exterior surface of specimen container 14. FIG. 1 shows width 66 of first arcuate gripping finger 38 and width 78 of second arcuate gripping finger 40 extending beyond the greatest diameter of specimen container 14. This extended surface area created by widths 66 and 78 reduces contamination of specimen container 14 due to both collected specimen 16 splashing out of specimen container 14 and the user not being able to collect the specimen without soiling the holder 22.

Specimen container gripping unit 88 is malleable such that when a specimen container 14 is inserted, first arcuate gripping finger 38 and second arcuate gripping finger 40 spread apart to securely hold specimen container 14, and gap 58 can increase to adapt to different size specimen containers 62. Although a preferred embodiment of the present invention is molded in recycled polystyrene, those skilled in the art will recognize other materials that can be similarly molded to avoid rigidity and brittleness but provide equivalent malleability such that the arcuate gripping fingers 38 and 40 can spread to accommodate varying sized specimen containers 62.

In the preferred embodiment of the present invention, specimen container holder 12 is molded such that handle 28 and specimen container gripping unit 88 together form a single unit. Those skilled in the art will recognize that there are many different methods to join handle 28 and gripping unit 88 such that the structural integrity of the specimen cup holder 12 is not compromised.

FIGS. 3 and 4 show alternate preferred embodiments of the specimen container gripping unit 88. FIG. 3 shows a perspective view of specimen container holder 22. Concave thickness 70 of first arcuate gripping finger 38 is greater than convex thickness 74 of first arcuate gripping finger 38. Also, concave thickness 82 (shown in FIG. 2) of second arcuate gripping finger 40 is greater than convex thickness 86 of second arcuate gripping finger 40. Because concave thicknesses 70 and 82 are in direct contact with specimen container 14 when specimen container 14 is placed in specimen container holder 22, the increased thicknesses provide extra support in gripping specimen container 14.

FIG. 4 shows an alternative preferred embodiment. A perspective view of specimen container holder 12 is shown. In this FIG. 4 embodiment, concave thickness 70 of first arcuate gripping finger 38 is substantially equal to convex thickness 74 of first arcuate gripping finger 38. Also, concave thickness 82 of second arcuate gripping finger 40 is substantially equal to convex thickness 86 of second arcuate gripping finger 40.

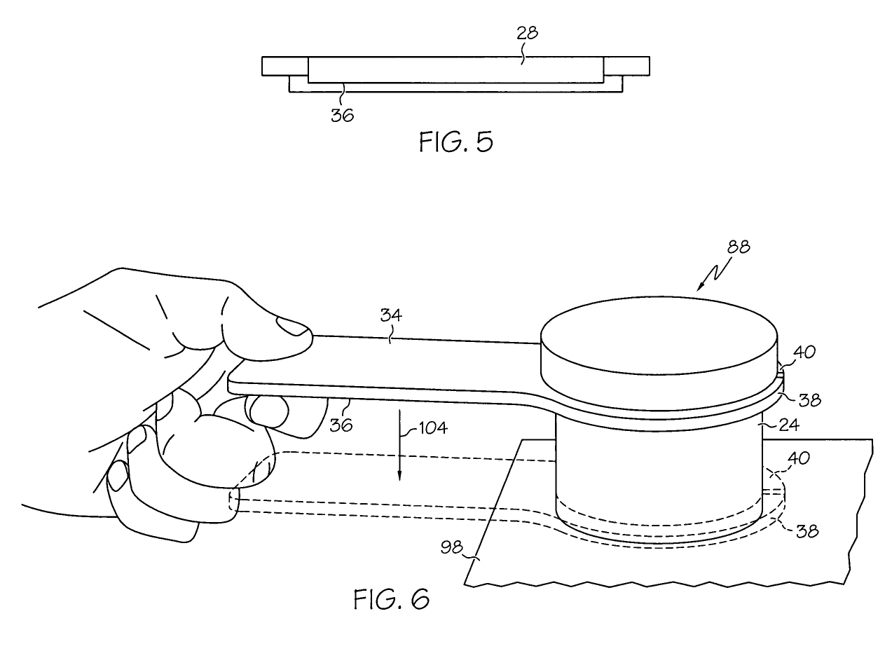

FIG. 5 shows a planar view of the specimen container holder 12 from the back. Bottom face 36 of handle 28 is substantially planar. In particular, bottom face 36 is absent of significant downward projections. Those skilled in the art will recognize that bottom face 36 need not be precisely planar, but rather can be slightly curved, particularly in a convex orientation. The structural advantage from such a configuration of bottom face 36 will become apparent from the below presented discussion concerning the method of using specimen container holder 22.

FIG. 6 shows a perspective view of specimen container holder 12 and depicts a method of using the specimen container holder 22. Prior to collecting specimen 16 (shown in FIG. 1), specimen container 14 is placed in gripping unit 88 of specimen container holder 22. After specimen 16 is collected, specimen container 14 is placed upon a surface 98, and a finger 100 and thumb 102 are placed on the top face 34 and bottom face 36 of the handle 28. In a preferred embodiment of the present invention, thumb 102 is placed on top face 34 of handle 28, and finger 100 is placed on bottom face 36 of handle 28. Using this finger 100 and thumb 102, a force 104 perpendicular to the surface 98 is placed upon the handle 28 such that specimen container holder 12 is pressed towards surface 98. This force 104 causes first arcuate gripping finger 38 and second arcuate gripping finger 40 to spread apart, increasing the size of gap 58. When gap 58 increases, specimen container holder 12 releases its secure grip upon specimen container 14, and specimen container gripping unit 88 slides down the specimen container 14. By providing a substantially flat bottom face 36, the force 104 of pressing the specimen cup holder 12 towards surface 98 is spread evenly across the finger 104 or thumb 10 that is in direct contact with bottom face 36, rather than concentrated on narrow lines of contact, as would occur if vertical reinforcement ribs were included.

In summary, the present invention teaches an improved specimen container holder 12 and a method of using it. The specimen container holder 12 allows an individual to easily and securely place a specimen container 14 to accept urine or other specimen 16 while seated. The holder 12 can securely hold multiple sizes of specimen containers 62 while receiving the specimen 16. While collecting a specimen 16, this specimen container holder 12 provides a rim around the specimen container 14 so that the potential for contaminating the exterior surface of the specimen container is limited. Furthermore, removing the specimen container 14 from specimen container holder 12 is easily done with one hand.

Although the preferred embodiments of the invention have been illustrated and described in detail, it will be readily apparent to those skilled in the art that various modifications may be made therein without departing from the spirit of the invention or from the scope of the appended claims.

What is claimed is:

1. A specimen container holder (12) comprising:
a handle (28), wherein a bottom face (36) of said handle (28) is substantially flat;
a first arcuate finger (38) joined to said handle (28); and
a second arcuate finger (40) joined to said handle (28), such that between said first arcuate finger (38) and said second arcuate finger (40) is an opening (60) configured to hold a specimen container (14).

2. The holder (12) of claim 1 wherein said first arcuate finger (38) and said second arcuate finger (40) are configured to spread apart when said specimen container (14) is inserted between said first (38) and second (40) arcuate fingers.

3. The holder (12) of claim 1 wherein said first arcuate finger (38) and said second arcuate finger (40) collectively circumscribe an angular distance (96) of more than 180° of said specimen container (14).

4. The holder (12) of claim 3 wherein said first arcuate finger (38) and said second arcuate finger (40) collectively circumscribe an angular distance (96) of more than 350° of said specimen container (14).

5. The holder (12) of claim 1 wherein said handle (28), said first arcuate finger (38), and said second arcuate finger (40) are molded as a single unit from recycled polystyrene.

6. The holder (12) of claim 1 wherein said first arcuate finger (38) and said second arcuate finger (40) do not touch.

7. The holder (12) of claim 1 wherein:
said first arcuate finger (38) has a concave rim (68), with a concave thickness (70);
said first arcuate finger (38) has an convex rim (72), with a convex thickness (74); and
said thickness (70) of said concave rim (68) of said first arcuate finger (38) is greater than said thickness (74) of said convex rim (72) of said first arcuate finger (38).

8. The holder (12) of claim 7 wherein:
said second arcuate finger (40) has a concave rim (80), with a concave thickness (82);
said second arcuate finger (40) has an convex rim (84), with a convex thickness (86); and
said thickness (82) of said concave rim (80) of said second arcuate finger (40) is greater than said thickness (86) of said convex rim (84) of said second arcuate finger (40).

9. The holder (12) of claim 1 wherein:
said first arcuate finger (38) and said second arcuate finger (40) together form a gripping unit (88); and
said handle (28) is cantilevered from said gripping unit (88).

10. The holder (12) of claim 1 wherein said handle (28) has a textured area (62) opposite said first (38) and second (40) arcuate fingers.

11. The holder (12) of claim 1 wherein:
said first arcuate finger (38) has a finger width (66);
said second arcuate finger (40) has a finger width (78);
said first arcuate finger (38) and said second arcuate finger (40) are joined together to form a gripping unit (88), with an internal diameter (90), wherein said finger width (66) of said first arcuate finger (38) and said finger width (78) of said second arcuate finger (40) increase the external diameter (92) of said gripping unit (88) such that, when said specimen container (14) is placed in said gripping unit (88), said internal diameter (90) is substantially equivalent to a diameter (22) of said specimen container (14), and said external diameter (92) of said gripping unit (88) is greater than greatest diameter (26) of said specimen container (14).

12. A method of using a specimen container (14) with a specimen container holder (12), said specimen container holder (12) having a handle (28), a first arcuate finger (38) and a second arcuate finger (40), said method comprising:
placing said specimen container (14) within said specimen container holder (12) such that said specimen container (14) is secured by said first arcuate finger (38) and said second arcuate finger (40);
placing said specimen container (14) with said specimen container holder (12) upon a surface (98); and
pressing said handle (28) of said specimen container holder (12) toward said surface (98), such that said first arcuate finger (38) and said second arcuate finger (40) slide down said specimen container (14).

13. The method of claim 12 wherein said pressing upon said handle (28) of said specimen container holder (12) spreads said first arcuate finger (38) away from said second arcuate finger (40), such that said specimen container holder (12) releases said specimen container (14).

14. A system (10) for collecting and transporting a specimen (66), comprising:
a specimen container (14); and
a specimen container holder (12);
wherein said specimen container holder (12) has a handle (28), having a bottom face (36) which is substantially flat, a first arcuate finger (38), and a second arcuate finger (40), said first arcuate finger (38) and said second arcuate finger (40) being cantilevered to said handle (28), with an opening (60) between said first arcuate finger (38) and said second arcuate finger (40) such that said specimen container (14) is secured between said first (38) and second (40) arcuate fingers.

15. The system (10) of claim 14 wherein said first arcuate finger (38) and said second arcuate finger (40) are configured to spread apart when said specimen container (14) is placed in said opening (60).

16. The system (10) of claim 14 wherein said first arcuate finger (38) and said second arcuate finger (40) collectively circumscribe an angular distance (96) of more than 180° of said specimen container (14).

17. The system (10) of claim 16 wherein said first arcuate finger (38) and said second arcuate finger (40) collectively circumscribes an angular distance (96) of more than 350° of said specimen container (14).

18. The system (10) of claim 14 wherein said specimen container holder (12) is molded as a single unit from recycled polystyrene.

19. The system (10) of claim 14 wherein:
said second arcuate finger (40) has a concave rim (80), with a concave thickness (82);
said second arcuate finger (40) has an convex rim (84), with a convex thickness (86); and
the thickness (82) of said concave rim (80) of said second arcuate finger (40) is greater than the thickness (86) of said convex rim (84) of said second arcuate finger (40).

20. The system of claim 14 wherein:
said first arcuate finger (38) and said second arcuate finger (40) together form a gripping unit (88); and
said handle (28) is cantilevered from said gripping unit (88).
said specimen container (14) is held within said gripping unit (88).
